(19) United States
(12) Patent Application Publication
(10) Pub. No.: US 2004/0030891 A1
(43) Pub. Date: Feb. 12, 2004

(54) Information processing system, information processing apparatus and method, recording medium, and program

(76) Inventor: Kuniaki Kurihara, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/361,828

(22) Filed: Feb. 11, 2003

(30) Foreign Application Priority Data
Feb. 14, 2002 (JP) P2002-036678

(51) Int. Cl. H04L 9/00

(52) U.S. Cl. 713/168; 380/277; 713/193

(57) ABSTRACT

When receiving a service provided by a service providing apparatus, a terminal generates a session key, which is sent to the service providing apparatus in an encrypted form using a shared secret key provided by an ID issuing apparatus. The terminal applies a hash function on an ID provided by the ID issuing apparatus, using the session key as a key, and sends the hash data and the ID to the service providing apparatus. The service providing apparatus determines the ID issuing apparatus that issued the ID received, and transfers the encrypted session key thereto. The ID issuing apparatus decrypts the session key using the shared secret key, and sends the result to the service providing apparatus. The service providing apparatus applies the hash function on the ID using the session key received, and executes authentication by determining whether the hash data calculated coincides with the hash data received from the terminal.

### BACKGROUND OF THE INVENTION

1. Field of the Invention

The present invention relates to information processing systems, information processing apparatuses and methods, recording media, and programs. More specifically, the present invention relates to an information processing system, an information processing apparatus and method, a recording medium, and a program that are suitable for use in an authentication process for providing a service.

2. Description of the Related Art

Recently, networks such as the Internet are becoming more and more common, and various apparatuses are coming to be connected to networks. Apparatuses connected to a network have their respective addresses that allow unique identification among the apparatuses within the network. At such an apparatus having an address that allows identification within a network, a user enters information required for personal authentication, such as a user name and a password, when using a service provided on the network, for example, an electronic mail service.

A particular service can be received only after undergoing personal authentication associated with the service. The authentication method based on information entered such as a user name and a password is valid even when an apparatus is shared by a plurality of users, and is in common use. However, it has been cumbersome for a user to enter information for authentication each time when receiving a service.

In view of the above problem, in an arrangement proposed in Japanese Unexamined Patent Application Publication No. 2000-321079, a user ID and a password are stored in an external storage device, and when the external storage device is connected to a navigation apparatus, the navigation apparatus accesses an external information-providing source using the user ID and the password stored in the external storage device. Accordingly, a user is allowed to access the external information-providing source without a cumbersome operation of entering a user ID and a password.

When an interface for connection to a network is changed, in some cases, addresses assigned to apparatuses connected to the network, which allow identification of the individual apparatuses, are also changed. When the addresses are changed, since the functions of apparatus identification and user identification are implemented in different layers, an authentication process must be executed again from the start, which is laborious for a user.

Furthermore, as the number of apparatuses connected to a network increases, it becomes more cumbersome for a user to enter information for authentication individually for each of the apparatuses when receiving services provided by the apparatuses via the network. Even if the arrangement disclosed in Japanese Unexamined Patent Application Publication No. 2000-321079 is used to avoid such a situation, each user is still required to set a user ID and a password.

### SUMMARY OF THE INVENTION

The present invention has been made in view of the situation described above, and an object thereof is to allow authentication without requiring a user who uses a plurality of apparatuses to perform a cumbersome operation of setting information for authentication individually for each of the apparatuses.

In order to achieve the above object, the present invention, in one aspect thereof, provides a first information processing system, including a first information processing apparatus for providing a service; a second information processing apparatus for providing information required for receiving the service; and a third information processing apparatus for receiving the service. The first information processing apparatus includes a storage unit for storing an identifier for identifying the second information processing apparatus, and an address of the second information processing apparatus associated with the identifier, the identifier and the address being associated with each other; a transferring unit for reading the address of the second information processing apparatus associated with the identifier when data including the identifier and a key that is encrypted are received from the third information processing apparatus, and transferring the key that is encrypted to the second information processing apparatus; and an authentication unit for receiving the key that has been decrypted, transmitted from the second information processing apparatus, and executing an authentication process using the key received. The second information processing apparatus includes a decryption unit for decrypting the key that is encrypted, transferred by the transferring unit; and a returning unit for returning the key that has been decrypted by the decryption unit to the first information processing apparatus. The third information processing apparatus includes a generating unit for generating the key; an encryption unit for encrypting the key generated by the generating unit; and a sending unit for sending the key encrypted by the encryption unit and the data including the identifier to the first information processing apparatus.

The present invention, in another aspect thereof, provides a first information processing apparatus, including a storage unit for storing an identifier for identifying a first apparatus, and an address of the first apparatus associated with the identifier, the identifier and the address being associated with each other; a receiving unit for receiving from a second apparatus data including the identifier as part of an address of the second apparatus, and a key that is encrypted; a transferring unit for reading from the storage unit the address of the first apparatus associated with the identifier received by the receiving unit, and transferring the key that is encrypted to the first apparatus; and an authentication unit for receiving the key that has been decrypted by the first apparatus, and executing an authentication process using the key received.

In the first information processing apparatus, preferably, the data received by the receiving unit includes first data used for authentication, generated by calculation of a hash function using the address of the second apparatus and the key in an unencrypted form, and the authentication unit executes the authentication process by determining whether the first data coincides with second data generated by calculation of the hash function using the address received by the receiving unit and the key that has been decrypted by the first apparatus.

Also, in the first information processing apparatus, the address of the second apparatus is preferably an address in an address space defined by the Internet Protocol version 6.

The present invention, in another aspect thereof, provides a first information processing method, including a storage-control step of controlling storage of a table in which an identifier for identifying a first apparatus and an address of the first apparatus associated with the identifier are associated with each other; a reception-control step of controlling reception of data including the identifier as part of an address of a second apparatus, and a key that is encrypted, transmitted from the second apparatus; a transferring step of reading the address of the first apparatus associated with the identifier received under control in the reception-control step, from the table stored under control in the storage-control step, and transferring the key that is encrypted to the first apparatus; and an authentication step of receiving the key that has been decrypted by the first apparatus, and of executing an authentication process using the key received.

The present invention, in another aspect thereof, provides a first computer-readable recording medium, having recorded thereon a program including a storage-control step of controlling storage of a table in which an identifier for identifying a first apparatus and an address of the first apparatus associated with the identifier are associated with each other; a reception-control step of controlling reception of data including the identifier as part of an address of a second apparatus, and a key that is encrypted, transmitted from the second apparatus; a transferring step of reading the address of the first apparatus associated with the identifier received under control in the reception-control step, from the table stored under control in the storage-control step, and transferring the key that is encrypted to the first apparatus; and an authentication step of receiving the key that has been decrypted by the first apparatus, and of executing an authentication process using the key received.

The present invention, in another aspect thereof, provides a first program, which allows a computer to execute a storage-control step of controlling storage of a table in which an identifier for identifying a first apparatus and an address of the first apparatus associated with the identifier are associated with each other; a reception-control step of controlling reception of data including the identifier as part of an address of a second apparatus, and a key that is encrypted, transmitted from the second apparatus; a transferring step of reading the address of the first apparatus associated with the identifier received under control in the reception-control step, from the table stored under control in the storage-control step, and transferring the key that is encrypted to the first apparatus; and an authentication step of receiving the key that has been decrypted by the first apparatus, and of executing an authentication process using the key received.

The present invention, in another aspect thereof, provides a second information processing apparatus, including a storage unit for storing an identifier assigned to the information processing apparatus, and a predetermined key, the identifier and the predetermined key being associated with each other; a providing unit for providing the identifier and the predetermined key stored in the storage unit to a first apparatus; a decryption unit for decrypting data that is encrypted, using the predetermined key stored in the storage unit, when the data is received from a second apparatus; and a sending unit for sending the data that has been decrypted by the decryption unit to the second apparatus.

The second information processing apparatus may further include an encryption unit for encrypting at least one of the identifier and the predetermined key provided by the providing unit.

The present invention, in another aspect thereof, provides a second information processing method, including a storage-control step of controlling storage of an identifier assigned to an information processing apparatus that executes the information processing method, and of a predetermined key, the identifier and the key being associated with each other; a providing step of providing the identifier and the predetermined key stored under control in the storage-control step to a first apparatus; a decryption step of decrypting data that is encrypted, using the predetermined key stored under control in the storage-control step, when the data is received from a second apparatus; and a sending-control step of controlling sending of the data that has been decrypted in the decryption step to the second apparatus.

The present invention, in another aspect thereof, provides a second computer-readable recording medium, having recorded thereon a program including a storage-control step of controlling storage of an identifier assigned to an information processing apparatus that executes the program, and of a predetermined key, the identifier and the key being associated with each other; a providing step of providing the identifier and the predetermined key stored under control in the storage-control step to a first apparatus; a decryption step of decrypting data that is encrypted, using the predetermined key stored under control in the storage-control step, when the data is received from a second apparatus; and a sending-control step of controlling sending of the data that has been decrypted in the decryption step to the second apparatus.

The present invention, in another aspect thereof, provides a second program, which allows a computer to execute a storage-control step of controlling storage of an identifier assigned to the computer, and of a predetermined key, the identifier and the key being associated with each other; a providing step of providing the identifier and the predetermined key stored under control in the storage-control step to a first apparatus; a decryption step of decrypting data that is encrypted, using the predetermined key stored under control in the storage-control step, when the data is received from a second apparatus; and a sending-control step of controlling sending of the data that has been decrypted in the decryption step to the second apparatus.

The present invention, in another aspect thereof, provides a third information processing apparatus, including a first generating unit for generating a key; a second generating unit for generating an address of the information processing apparatus, the address including an identifier for identifying a first apparatus, supplied from the first apparatus; a third generating unit for generating authentication data using the key generated by the first generating unit and the address generated by the second generating unit; and a sending unit for sending the key generated by the first generating unit and encrypted by a second apparatus, and the address generated by the second generating unit, together with the authentication data generated by the third generating unit, to a third apparatus.

In the third information processing apparatus, preferably, the identifier is supplied from the first apparatus to the second apparatus and stored in the second apparatus, and the second generating unit generates an address including the identifier stored in the second apparatus.

Also, in the third information processing apparatus, the first generating unit preferably updates the key at a predetermined interval.

Also, in the third information processing apparatus, the third generating unit preferably generates authentication data by calculation of a hash function using the address generated by the second generating unit and the key generated by the first generating unit.

The present invention, in another aspect thereof, provides a third information processing method, including a first generating step of generating a key; a second generating step of generating an address of an information processing apparatus that executes the information processing method, the address including an identifier for identifying a first apparatus, supplied from the first apparatus; a third generating step of generating authentication data using the key generated in the first generating step and the address generated in the second generating step; and a sending-control step of controlling sending of the key generated in the first generating step and encrypted by a second apparatus, and of the address generated in the second generating step, together with the authentication data generated in the third generating step, to a third apparatus.

The present invention, in another aspect thereof, provides a third computer-readable recording medium, having recorded thereon a program including a first generating step of generating a key; a second generating step of generating an address of an information processing apparatus that executes the program, the address including an identifier for identifying a first apparatus, supplied from the first apparatus; a third generating step of generating authentication data using the key generated in the first generating step and the address generated in the second generating step; and a sending-control step of controlling sending of the key generated in the first generating step and encrypted by a second apparatus, and of the address generated in the second generating step, together with the authentication data generated in the third generating step, to a third apparatus.

The present invention, in another aspect thereof, provides a third program, which allows a computer to execute a first generating step of generating a key; a second generating step of generating an address of the computer, the address including an identifier for identifying a first apparatus, supplied from the first apparatus; a third generating step of generating authentication data using the key generated in the first generating step and the address generated in the second generating step; and a sending-control step of controlling sending of the key generated in the first generating step and encrypted by a second apparatus, and of the address generated in the second generating step, together with the authentication data generated in the third generating step, to a third apparatus.

The present invention, in another aspect thereof, provides a fourth information processing apparatus, including a storage unit for storing an identifier supplied from a first apparatus, and a first key associated with the identifier; a reading unit for reading the identifier and the first key stored in the storage unit when a second key is supplied from a second apparatus; an encryption unit for encrypting the second key using the first key read by the reading unit; and a supplying unit for supplying the identifier read by the reading unit and the second key encrypted by the encryption unit to the second apparatus.

The fourth information processing apparatus may further include a decryption unit for decrypting the first key when the first key is encrypted.

The present invention, in another aspect thereof, provides a fourth information processing method, including a storage-control step of controlling storage of an identifier supplied from a first apparatus and of a first key associated with the identifier; a reading-control step of controlling reading of the identifier and the first key stored under control in the storage-control step when a second key is supplied from a second apparatus; an encryption step of encrypting the second key using the first key read under control in the reading-control step; and a supplying step of supplying the identifier read under control in the reading-control step and the second key encrypted in the encryption step to the second apparatus.

The present invention, in another aspect thereof, provides a fourth computer-readable recording medium, having recorded thereon a program including a storage-control step of controlling storage of an identifier supplied from a first apparatus and of a first key associated with the identifier; a reading-control step of controlling reading of the identifier and the first key stored under control in the storage-control step when a second key is supplied from a second apparatus; an encryption step of encrypting the second key using the first key read under control in the reading-control step; and a supplying step of supplying the identifier read under control in the reading-control step and the second key encrypted in the encryption step to the second apparatus.

The present invention, in another aspect thereof, provides a fourth program, which allows a computer to execute a storage-control step of controlling storage of an identifier supplied from a first apparatus and of a first key associated with the identifier; a reading-control step of controlling reading of the identifier and the first key stored under control in the storage-control step when a second key is supplied from a second apparatus; an encryption step of encrypting the second key using the first key read under control in the reading-control step; and a supplying step of supplying the identifier read under control in the reading-control step and the second key encrypted in the encryption step to the second apparatus.

The present invention, in another aspect thereof, provides a second information processing system, including a first information processing apparatus for providing a service; and a second information processing apparatus for receiving the service. The first information processing apparatus includes a storage unit for storing an identifier for identifying a service, and identity of the service associated with the identifier, the identifier and the identity of the service being associated with each other; a decryption unit for decrypting a key that is encrypted, when the key is received from the second information processing apparatus; and an authentication unit for executing an authentication process using the key that has been decrypted by the decryption unit. The second information processing apparatus includes a generating unit for generating the key; an encryption unit for encrypting the key generated by the generating unit; and a sending unit for sending the key encrypted by the encryption unit and data including the identifier to the first information processing apparatus.

The present invention, in another aspect thereof, provides a fifth information processing apparatus, including a storage unit for storing an identifier for identifying a service, and identity of the service associated with the identifier, the identifier and the identity of the service being associated with each other; a receiving unit for receiving at least an address of a predetermined apparatus, authentication data, and a key that is encrypted, transmitted from the predetermined apparatus; a decryption unit for decrypting the key that is encrypted, received by the receiving unit; and an authentication unit for executing an authentication process by determining whether data generated by calculation of a hash function using the address received by the receiving unit and the key that has been decrypted by the decryption unit coincides with the authentication data received by the receiving unit.

The present invention, in another aspect thereof, provides a fifth information processing method, including a storage-control step of controlling storage of an identifier for identifying a service and of identity of the service associated with the identifier, the identifier and the identity of the service being associated with each other; a reception-control step of controlling reception of at least an address of a predetermined apparatus, authentication data, and a key that is encrypted, transmitted from the predetermined apparatus; a decryption step of decrypting the key that is encrypted, received under control in the reception-control step; and an authentication step of executing an authentication process by determining whether data generated by calculation of a hash function using the address received under control in the reception-control step and the key that has been decrypted in the decryption step coincides with the authentication data received under control in the reception-control step.

The present invention, in another aspect thereof, provides a fifth computer-readable recording medium, having recorded thereon a program including a storage-control step of controlling storage of an identifier for identifying a service and of identity of the service associated with the identifier, the identifier and the identity of the service being associated with each other; a reception-control step of controlling reception of at least an address of a predetermined apparatus, authentication data, and a key that is encrypted, transmitted from the predetermined apparatus; a decryption step of decrypting the key that is encrypted, received under control in the reception-control step; and an authentication step of executing an authentication process by determining whether data generated by calculation of a hash function using the address received under control in the reception-control step and the key that has been decrypted in the decryption step coincides with the authentication data received under control in the reception-control step.

The present invention, in another aspect thereof, provides a fifth program, which allows a computer to execute a storage-control step of controlling storage of an identifier for identifying a service and of identity of the service associated with the identifier, the identifier and the identity of the service being associated with each other; a reception-control step of controlling reception of at least an address of a predetermined apparatus, authentication data, and a key that is encrypted, transmitted from the predetermined apparatus; a decryption step of decrypting the key that is encrypted, received under control in the reception-control step; and an authentication step of executing an authentication process by determining whether data generated by calculation of a hash function using the address received under control in the reception-control step and the key that has been decrypted in the decryption step coincides with the authentication data received under control in the reception-control step.

Operations of the present invention will be described below.

According to the first information processing system of the present invention, the first information processing apparatus, when data including the identifier and the encrypted key are received from the third apparatus, reads the address of the second information processing apparatus associated with the identifier, transfers the encrypted key to the second information processing apparatus, receives the decrypted key from the second information processing apparatus, and executes an authentication process using the key received. The second information processing apparatus decrypts the encrypted key, transmitted from the first information processing apparatus, and returns the decrypted key to the first information processing apparatus. The third information processing apparatus generates and encrypts the key, and sends the key and data including the identifier to the first information processing apparatus. Accordingly, even when, for example, a network connection of the third information processing apparatus is altered, an authentication process is properly executed without bothering a user.

According to the second information processing system of the present invention, the first information processing apparatus decrypts the encrypted key received from the second information processing apparatus, decrypts the encrypted key, and executes an authentication process using the decrypted key. The second information processing apparatus generates and encrypts the key, and sends the key and data including the identifier to the first information processing apparatus. Accordingly, even when, for example, a network connection of the second information processing apparatus is altered, an authentication process is properly executed without bothering a user.

According to the first information processing apparatus, information processing method, recording medium, and program, data including the identifier as part of the address of the second apparatus, and the encrypted key are received, the address of the first apparatus associated with the identifier received is read, the encrypted key is transferred to the first apparatus, the key that has been decrypted by the first apparatus is received, and the authentication process is executed using the key received. Accordingly, robustness against unauthorized acts relating to authentication is improved.

According to the second information processing apparatus, information processing method, recording medium, and program, the identifier and the predetermined key that have been stored are provided to the first apparatus. When the encrypted data is received, the encrypted data is decrypted using the predetermined key that has been stored, and the data that has been decrypted is sent to the second apparatus. Accordingly, the authentication process executed at the second apparatus achieves an improved validity of authentication.

According to the third information processing apparatus, information processing method, recording medium, and program, the key is generated and encrypted, the address of the information processing apparatus, including the identifier for identifying the first apparatus, is generated, the authentication data is generated using the key and address generated, and the key encrypted by the second apparatus, and the address as well as the authentication data generated are sent to the third apparatus. Accordingly, even when, for example, a network connection is altered, an authentication process is executed by the third apparatus without bothering a user.

According to the fourth information processing apparatus, information processing method, recording medium, and program, when the second key is supplied from the second apparatus, the second key is encrypted using the first key that has been read, and the identifier that has been read and the second key that is encrypted are supplied to the second apparatus. Accordingly, information used for authentication processes executed by other apparatuses is prevented from being abused.

According to the fifth information processing apparatus, information processing method, recording medium, and program, the encrypted key that has been received is decrypted, and the authentication process is executed by determining whether the data generated by calculation of the hash function using the address received and the decrypted key coincides with the authentication data received. Accordingly, validity of authentication is improved.

### BRIEF DESCRIPTION OF THE DRAWINGS

FIG. 1 is a block diagram showing the configuration of an information processing system according to an embodiment of the present invention;

FIG. 2 is a functional block diagram of an ID issuing apparatus;

FIG. 3 is a diagram showing an example internal configuration of a service providing apparatus;

FIG. 4 is a functional block diagram of the service providing apparatus;

FIG. 5 is a diagram showing a table stored in a table storage unit;

FIG. 6 is a functional block diagram of a terminal;

FIG. 7 is a diagram showing a table stored in a table storage unit;

FIG. 8 is a flowchart showing an operation of the information processing system shown in FIG. 1;

FIG. 9 is a diagram for explaining the operation of the information processing system shown in FIG. 1;

FIG. 10 is a diagram showing the configuration of an information processing system according to another embodiment of the present invention;

FIG. 11 is a functional block diagram of an ID and service providing apparatus;

FIG. 12 is a diagram showing a table stored in a table storage unit; and

FIG. 13 is a flowchart showing an operation of the information processing apparatus shown in FIG. 10.

### DESCRIPTION OF THE PREFERRED EMBODIMENTS

Before describing preferred embodiments of the present invention, corresponding relationships between features of the present invention as defined in claims and specific examples according to the embodiments will be described in order to ensure that specific examples supporting the present invention as defined in claims are given in the description of the embodiments. It is to be understood, however, that there may exist specific examples not explicitly included in the following description but still covered by the features of the present invention. Conversely, even if a specific example is described herein as relating to a particular feature of the present invention, it is possible that the specific example relates to other features of the present invention as well.

Furthermore, it is to be noted that claims do not necessarily include all the features of the present invention corresponding to specific examples in the description of the embodiments. That is, there may exist features of the present invention relating to specific examples in the description of the embodiments but not included in claims, which may be added in the future, for example, by a divisional application, by amendment, or by claiming priority.

A first information processing system according to the present invention, in its basic configuration, at least includes a first information processing apparatus that serves as a server apparatus for providing a predetermined service; a second information processing apparatus that serves as a server apparatus for issuing information for receiving the service, such as an ID; and a third information processing apparatus that serves as a user terminal for a user to receive the service.

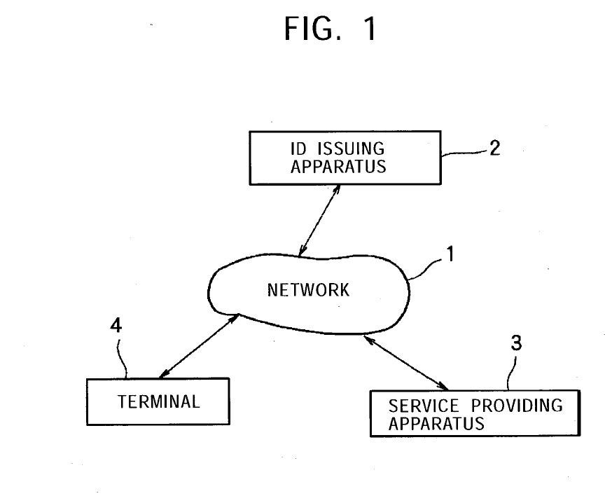

In an embodiment of the present invention, as an example, the first information processing apparatus is a service providing apparatus 3 shown in FIG. 1, the second information processing apparatus is an ID issuing apparatus 2 shown in FIG. 1, and the third information processing apparatus is a terminal 4 shown in FIG. 1.

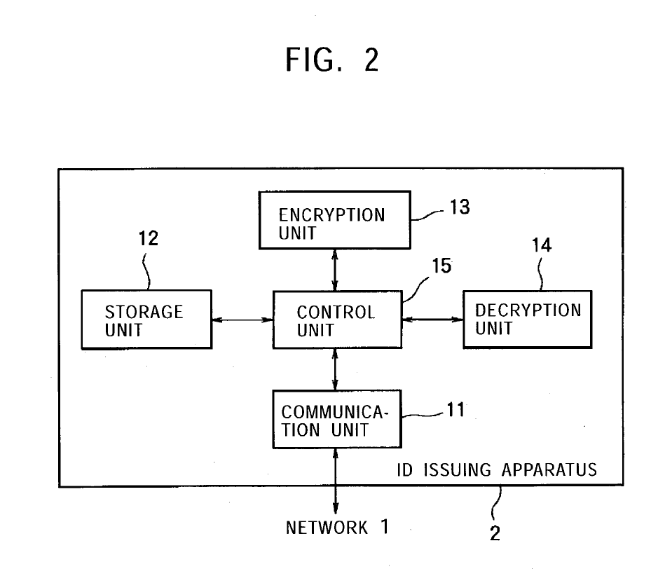

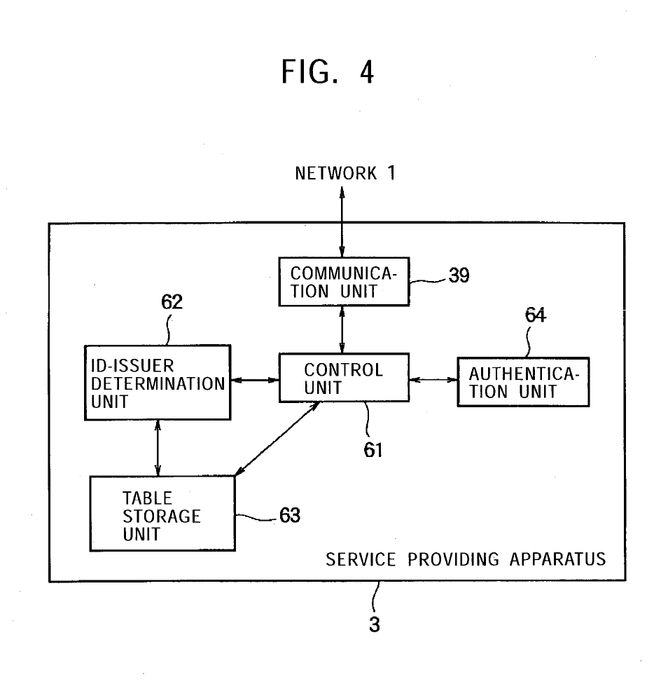

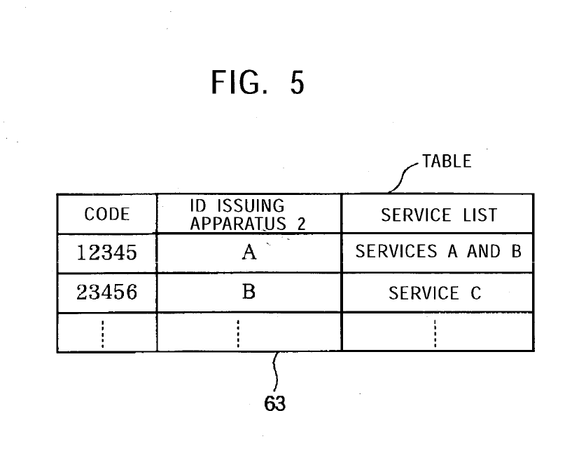

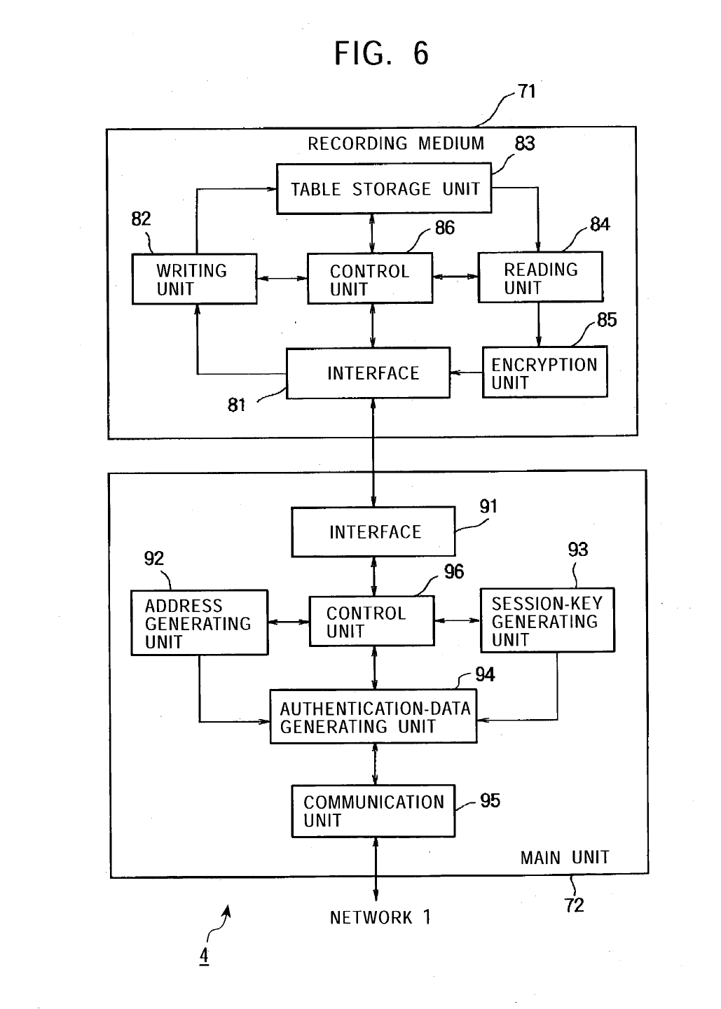

In the basic configuration of the first information processing system according to the present invention, the first information processing apparatus at least includes a storage unit (e.g., table storage unit 63 shown in FIG. 4) for storing an identifier (e.g., code shown in FIG. 5) for identifying the second information processing apparatus, and an address of the second information processing apparatus associated with the identifier, the identifier and the address being associated with each other; a transferring unit (e.g., communication unit 39 shown in FIG. 4) for reading the address of the second information processing apparatus associated with the identifier when data including the identifier and a key (e.g., session key) that is encrypted are received from the third information processing apparatus, and transferring the key that is encrypted to the second information processing apparatus; and an authentication unit (e.g., authentication unit 64 shown in FIG. 4) for receiving the key that has been decrypted, transmitted from the second information processing apparatus, and executing an authentication process using the key received. The second information processing apparatus at least includes a decryption unit (e.g., decryption unit 14 shown in FIG. 2) for decrypting the key that is encrypted, transferred by the transferring unit; and a returning unit (e.g., communication unit 11 shown in FIG. 2) for returning the key that has been decrypted by the decryption unit to the first information processing apparatus. The third information processing apparatus at least includes a generating unit (e.g., session-key generating unit 93 shown in FIG. 6) for generating the key; an encryption unit (e.g., encryption unit 85 shown in FIG. 6) for encrypting the key generated by the generating unit; and a sending unit (e.g., communication unit 95 shown in FIG. 6) for sending the key encrypted by the encryption unit and the data including the identifier to the first information processing apparatus.

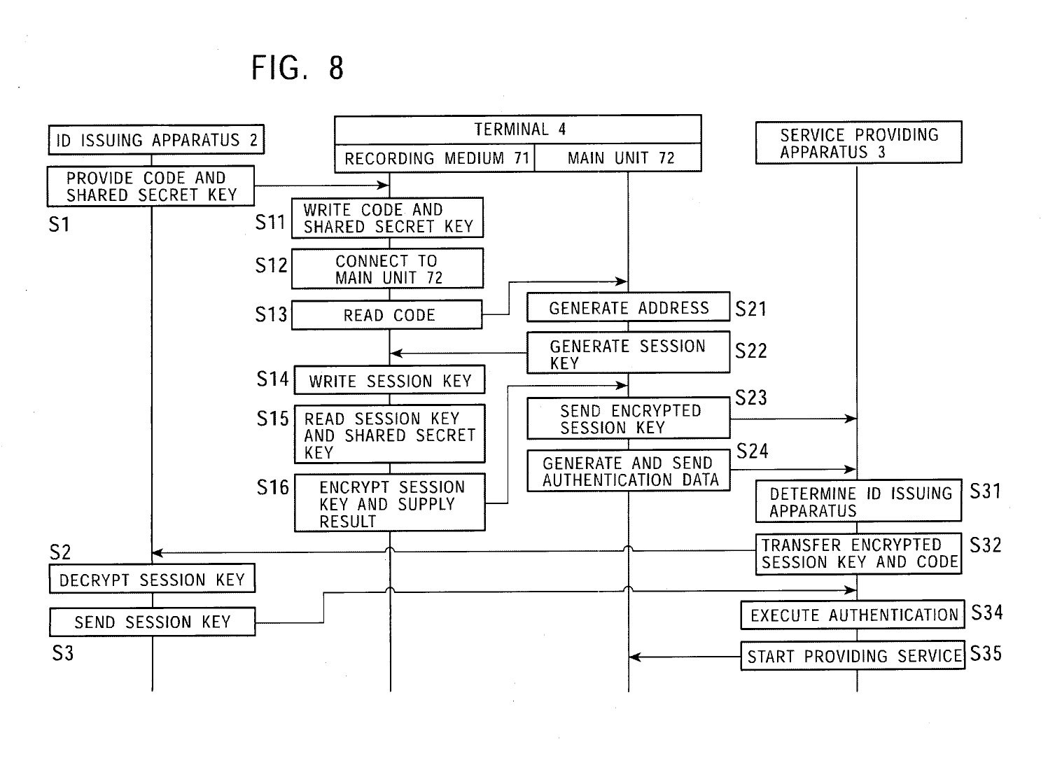

An information processing apparatus according to the present invention, for example, a service providing apparatus 3 shown in FIG. 4 as an embodiment of the present invention, in its basic configuration, at least includes a storage unit (e.g., table storage unit 63 shown in FIG. 4) for storing an identifier (e.g., code shown in FIG. 5) for identifying a first apparatus (e.g., ID issuing apparatus 2), and an address of the first apparatus associated with the identifier, the identifier and the address being associated with each other; a receiving unit for receiving from a second apparatus (e.g., terminal 4) data (e.g., source address) including the identifier as part of an address of the second apparatus, and a key (e.g., session key) that is encrypted; a transferring unit (e.g., communication unit 39 shown in FIG. 4, which executes step S32 shown in FIG. 8) for reading from the storage unit the address of the first apparatus associated with the identifier received by the receiving unit, and transferring the key that is encrypted to the first apparatus; and an authentication unit (e.g., authentication unit 64 shown in FIG. 4, which executes step S34 shown in FIG. 8) for receiving the key that has been decrypted by the first apparatus, and executing an authentication process using the key received.

An information processing apparatus according to the present invention, for example, an ID issuing apparatus 2 shown in FIG. 2 as an embodiment of the present invention, in its basic configuration, at least includes a storage unit (e.g., storage unit 12 shown in FIG. 2) for storing an identifier assigned to the information processing apparatus, and a predetermined key (e.g., shared secret key), the identifier and the predetermined key being associated with each other; a providing unit (e.g., communication unit 11 shown in FIG. 2, which executes step S1 in FIG. 8) for providing the identifier and the predetermined key stored in the storage unit to a first apparatus (e.g., terminal 4); a decryption unit (e.g., decryption unit 14 shown in FIG. 2, which executes step S2 shown in FIG. 8) for decrypting data that is encrypted, using the predetermined key stored in the storage unit, when the data is received from a second apparatus (e.g., service providing apparatus 3); and a sending unit (e.g., communication unit 11 shown in FIG. 2, which executes step S3 shown in FIG. 8) for sending the data that has been decrypted by the decryption unit to the second apparatus.

The information processing apparatus, serving as the ID issuing apparatus 2, may further include an encryption unit (e.g., encryption unit 13 shown in FIG. 2) for encrypting at least one of the identifier and the predetermined key provided by the providing unit.

An information processing apparatus according to the present invention, for example, a main unit 72 of a terminal 4 shown in FIG. 6 as an embodiment of the present invention, in its basic configuration, at least includes a first generating unit (e.g., session-key generating unit 93 shown in FIG. 6, which executes step S22 shown in FIG. 8) for generating a key (e.g., session key); a second generating unit (e.g., address generating unit 92 shown in FIG. 6, which executes step S21 shown in FIG. 8) for generating an address (e.g., source address) of the information processing apparatus, the address including an identifier (e.g., code) for identifying a first apparatus (e.g., ID issuing apparatus 2), supplied from the first apparatus; a third generating unit (e.g., authentication-data generating unit 94 shown in FIG. 6, which executes step S23 shown in FIG. 8) for generating authentication data using the key generated by the first generating unit and the address generated by the second generating unit; and a sending unit (e.g., communication unit 95 shown in FIG. 6, which executes step S24 shown in FIG. 8) for sending the key (e.g., session key encrypted using shared secret key) generated by the first generating unit and encrypted by a second apparatus (e.g., recording medium 71 shown in FIG. 6), and the address generated by the second generating unit, together with the authentication data generated by the third generating unit, to a third apparatus (e.g., service providing apparatus 3).

An information processing apparatus according to the present invention, for example, a recording medium 71 of a terminal 4 shown in FIG. 6 as an embodiment of the present invention, in its basic configuration, at least includes a storage unit (e.g., table storage unit 83 shown in FIG. 6) for storing an identifier supplied from a first apparatus (e.g., ID issuing apparatus 2), and a first key (e.g., shared secret key) associated with the identifier; a reading unit (e.g., reading unit 84 shown in FIG. 6, which executes steps S13 and S15 shown in FIG. 8) for reading the identifier and the first key stored in the storage unit when a second key (e.g., session key) is supplied from a second apparatus (e.g., main unit 72 shown in FIG. 6); an encryption unit (e.g., encryption unit 85 shown in FIG. 6, which executes step S16 shown in FIG. 8) for encrypting the second key using the first key read by the reading unit; and a supplying unit (e.g., interface 81 shown in FIG. 6) for supplying the identifier read by the reading unit and the second key encrypted by the encryption unit to the second apparatus.

A second information processing system according to the present invention, in its basic configuration, at least includes a first information processing apparatus that serves as a server apparatus for providing (issuing) a service, and information for allowing access to the service, such as an ID, and also includes a second information processing apparatus that serves as a user terminal for a user to receive the service.

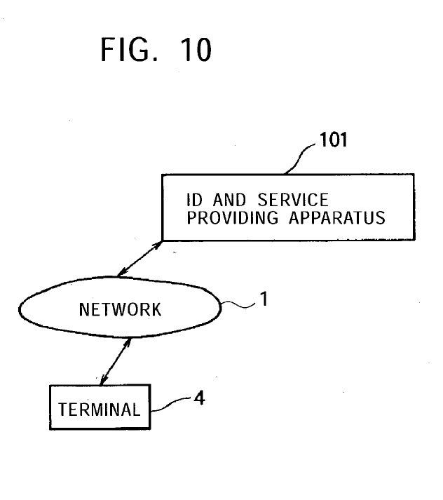

In an embodiment of the present invention, as an example, the first information processing apparatus is an ID and service providing apparatus 101 shown in FIG. 10, and the second information processing apparatus is a terminal 4 shown in FIG. 10.

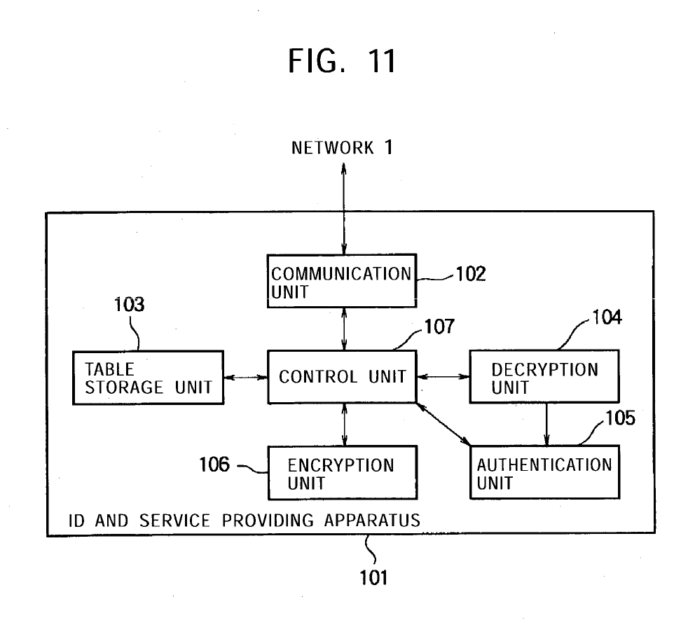

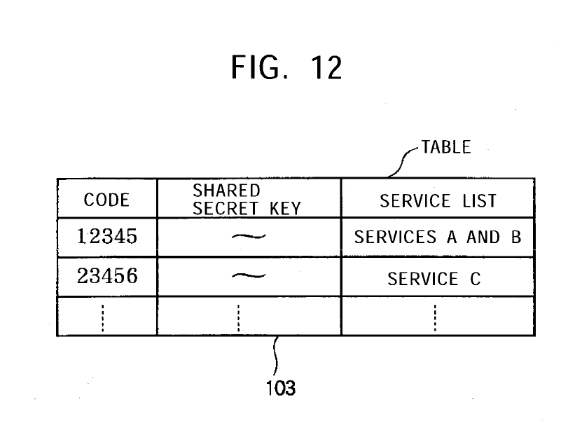

In the basic configuration of the second information processing system according to the present invention, the first information processing apparatus at least includes a storage unit (e.g., table storage unit 103 shown in FIGS. 11 and 12) for storing an identifier for identifying a service, and identity of the service associated with the identifier, the identifier and the identity of the service being associated with each other; a decryption unit (e.g., decryption unit 104 shown in FIG. 11) for decrypting a key that is encrypted, when the key is received from the second information processing apparatus; and an authentication unit (e.g., authentication unit 105 shown in FIG. 11) for executing an authentication process using the key that has been decrypted by the decryption unit. The second information processing apparatus at least includes a generating unit (e.g., session-key generating unit 93 shown in FIG. 6) for generating the key; an encryption unit (e.g., encryption unit 85 shown in FIG. 6) for encrypting the key generated by the generating unit; and a sending unit (e.g., communication unit 95 shown in FIG. 6) for sending the key encrypted by the encryption unit and data including the identifier to the first information processing apparatus.

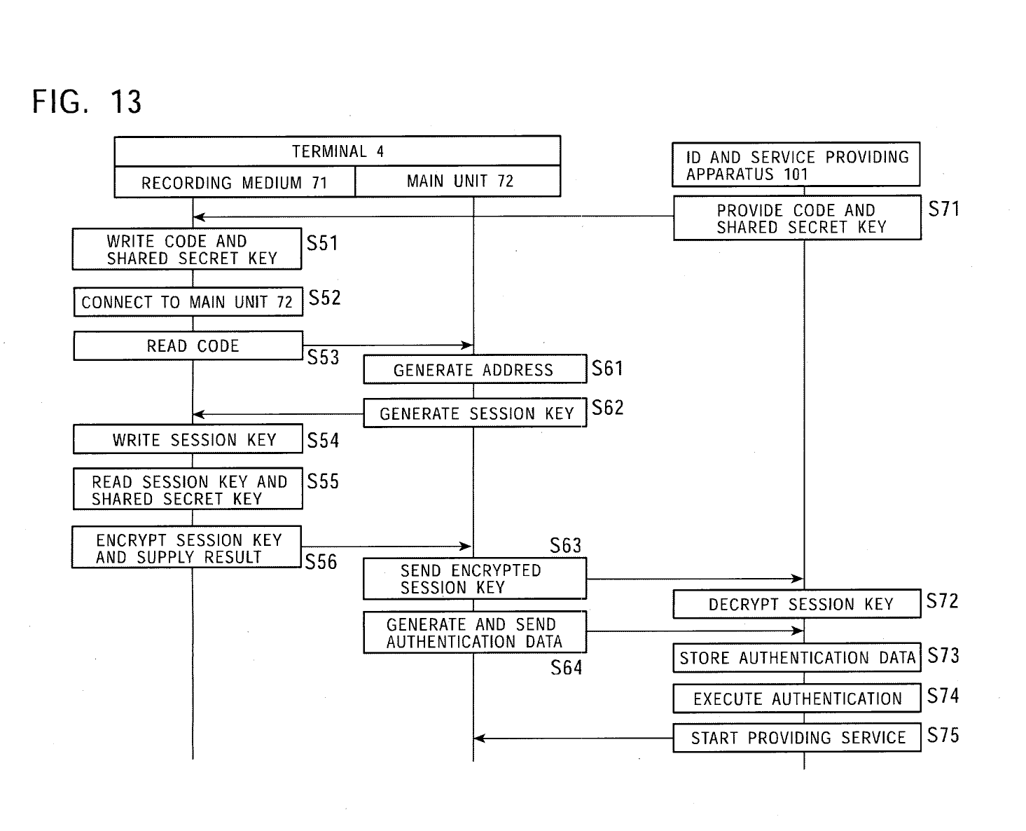

An information processing apparatus according to the present invention, for example, an ID and service providing apparatus shown in FIG. 11 as an embodiment of the present invention, in its basic configuration, at least includes a storage unit (table storage unit 103 shown in FIG. 11) for storing an identifier for identifying a service, and identity of the service associated with the identifier, the identifier and the identity of the service being associated with each other; a receiving unit (communication unit 102 shown in FIG. 11) for receiving at least an address of a predetermined apparatus (e.g., terminal 4), authentication data, and a key (e.g., session key) that is encrypted, transmitted from the predetermined apparatus; a decryption unit (e.g., decryption unit 104 shown in FIG. 11, which executes step S73 shown in FIG. 13) for decrypting the key that is encrypted, received by the receiving unit; and an authentication unit (e.g., authentication unit 75 shown in FIG. 11, which executes step S74 shown in FIG. 13) for executing an authentication process by determining whether data generated by calculation of a hash function using the address received by the receiving unit and the key that has been decrypted by the decryption unit coincides with the authentication data received by the receiving unit.

Now, preferred embodiments of the present invention will be described with reference to the drawings.

FIG. 1 is a diagram showing the configuration of an information processing system according to an embodiment of the present invention. Referring to FIG. 1, a network 1 is a network such as the Internet or a LAN (local area network). To the network 1, an ID issuing apparatus 2 for issuing an ID, a service providing apparatus 3 for providing a service, and a user terminal 4 for receiving the ID issued by the ID issuing apparatus 2 and the service provided by the service providing apparatus 3 are connected.

Although the ID issuing apparatus 2 and the service providing apparatus 3 are described as separate apparatuses herein, the function of the ID issuing apparatus 2 may be integrated into the service providing apparatus 3 so that the service providing apparatus 3 will be in charge of issuing to the terminal 4 an ID for allowing access to the service it provides. That is, the function of the ID issuing apparatus 2 and the function of the service providing apparatus 3 may be managed by separate managers or by a single manager.

Although only the single ID issuing apparatus 2, the single service providing apparatus 3, and the single terminal 4 are shown for convenience of description, actually, a plurality of ID issuing apparatuses, a plurality of service providing apparatuses, and a plurality of terminals exist.

FIG. 2 is a functional block diagram of the ID issuing apparatus 2. Referring to FIG. 2, a communication unit 11 exchanges data with the service providing apparatus 3 and the terminal 4 via the network 1. A storage unit 12 stores a shared secret key and a code. The shared secret key and the code will be described later. An encryption unit 13 encrypts the shared secret key and the code stored in the storage unit 12 before the shared secret key and the code are supplied to the terminal 4 (or a recording medium detachable from the terminal 4).

If it is ensured that the shared secret key and the code are supplied securely, that is, if the risk that the key is intercepted or otherwise compromised while the key is being supplied is sufficiently low, for example, if the shared secret key and the code are directly written to a recording medium detachable from the terminal 4, the shared secret key and the code may be supplied without being encrypted by the encryption unit 13.

A decryption unit 14 decrypts encrypted data supplied from the service providing apparatus 3 via the network 1. A control unit 15 controls each of the units of the ID issuing apparatus 2. For example, the control unit 15 supplies data received by the communication unit 11 to the decryption unit 14, and supplies data from the storage unit 12 or the decryption unit 14 to the encryption unit 13 or the communication unit 11.

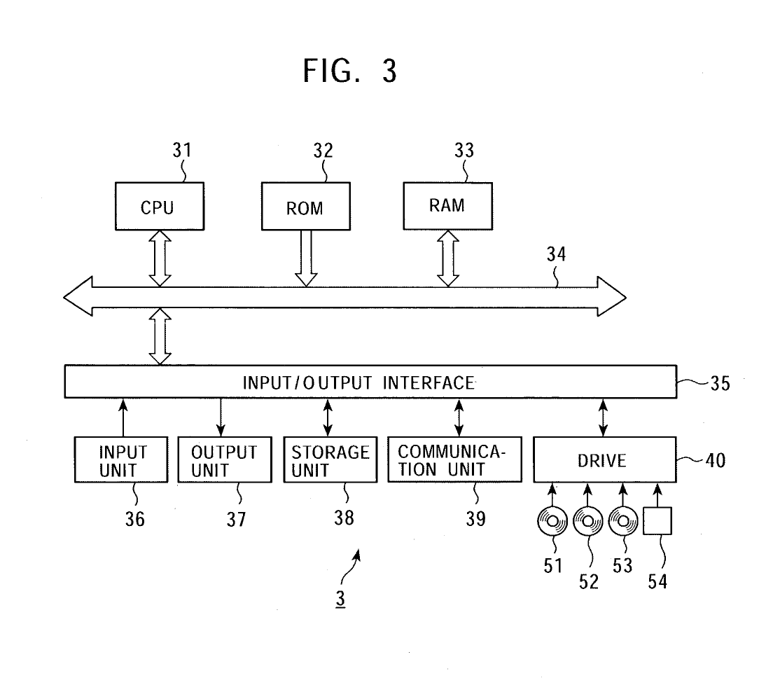

FIG. 3 is a diagram showing an example internal configuration of the service providing apparatus 3. Referring to FIG. 3, a CPU (central processing unit) 31 of the service providing apparatus 3 executes various processes according to programs stored in a ROM (read-only memory) 32. A RAM (random access memory) 33 stores data, programs, etc. as required by the CPU 31 in executing various processes. An input/output interface 35 is connected to an input unit 36 including a keyboard and a mouse, and it outputs a signal input to the input unit 36 to the CPU 31. The input/output interface 35 is also connected to an output unit 37 including a display and a speaker.

Furthermore, the input/output interface 35 is connected to a storage unit 38 implemented by a hard disk or the like, and to a communication unit 39 for exchanging data with other apparatuses (e.g., the terminal 4) via the network 1 such as the Internet. A drive 40 is used to read data from and write data to a recording medium, such as a magnetic disk 51, an optical disk 52, a magneto-optical disk 53, or a semiconductor memory 54.

FIG. 4 is a functional block diagram of the service providing apparatus 3. Referring to FIG. 4, when the communication unit 39 receives data from the terminal 4, a control unit 61 supplies the data to an ID-issuer determination unit 62. The ID-issuer determination unit 62 uniquely determines the ID issuing apparatus 2 that has issued the ID to the terminal 4, based on the data supplied and with reference to a table stored in a table storage unit 63. The table storage unit 63 stores a table in which codes, identities of ID issuing apparatuses including the ID issuing apparatus 2, and lists of services provided are associated with each other, as shown in FIG. 5.

The data from the terminal 4 includes a code, and the ID issuing apparatus 2 can be determined based on the code and with reference to the table. The control unit 61 sends the data from the terminal 4 to the ID issuing apparatus 2 determined by the ID-issuer determination unit 62. An authentication unit 64 executes authentication using data transmitted from the ID issuing apparatus 2 in response and the data from the terminal 4. A service is provided based on the service list stored in the table, only when the authentication succeeds.

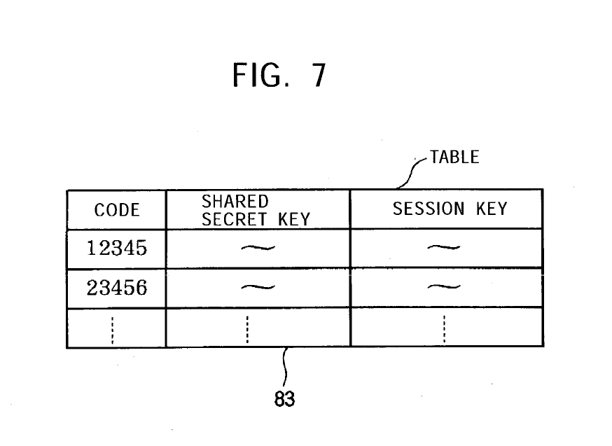

FIG. 6 is a diagram showing an example internal configuration of the terminal 4. Referring to FIG. 6, the terminal 4 includes a recording medium 71 and a main unit 72. The recording medium 71 is detachable from the main unit 72. The recording medium 71 has an interface 81 for exchanging data with the main unit 72. Data input to the interface 81 from the main unit 72 is stored in a table storage unit 83 by a writing unit 82. The table storage unit 83 stores a table as shown in FIG. 7.

The table stored in the table storage unit 83 includes sets of code, shared secret key, and session key associated with each other, including a set associated with the ID issuing apparatus 2. The code and the shared secret key are supplied from the ID issuing apparatus 2, and the session shared secret key are encrypted, the code and the shared secret key are decrypted before being written to the table by the writing unit 82. The session key is generated and supplied by the main unit 72 by a process that will be described later. The table includes a plurality of sets of code, shared secret key, and session key.

A reading unit 84 reads the code, the shared secret key, and the session key stored in the table storage unit 83. An encryption unit 85 encrypts the session key using the shared secret key also read by the reading unit 84. The encrypted session key is supplied to the main unit 72 via the interface 81. A control unit 86 controls each of the units of the recording medium 71.

The encryption and decryption executed in the ID issuing apparatus 2 and the terminal 4 may be based on, for example, DES (Data Encryption Standard).

An interface 91 of the main unit 72 exchanges data with the recording medium 71. An address generating unit 92 generates an address by combining the code read from the table storage unit 83 of the recording medium 71 and an identifier for identifying the main unit 72 of the terminal 4. For example, if the address space defined in IPv6 (Internet Protocol Version 6) is used, the address consists of 128 bits, of which the higher 64 bits are a network ID for identifying a network to which the terminal 4 is connected, and the lower 64 bits are an interface ID for identifying the terminal 4.

In this example, the code stored in the table storage unit 83 of the recording medium 71 is used as the interface ID. Alternatively, a format based on EUI64 may be used.

It is to be understood that the address generated by the address generating unit 92 need not be an address in the address space defined in IPv6. The number of bits of the address generated may be any number of bits as long as the address includes data that allows unique identification of the terminal 4 and data that allows unique identification of the ID issuing apparatus 2.

A session-key generating unit 93 generates a session key. Using the address generated by the address generating unit 92 and the session key generated by the session-key generating unit 93, an authentication-data generating unit 94 generates authentication data that is used when an authentication process is executed by the service providing apparatus 3. The authentication data may be based on, for example, an authentication method defined in IPv6. It is to be understood that an authentication process may be executed based on other methods using authentication data generated in accordance the relevant method.

The authentication generated by the authentication-data generating unit 94 is transmitted from a communication unit 95 to the service providing apparatus 3 via the network 1. A control unit 96 controls each of the units of the main unit 72.

Next, an operation of the information processing system shown in FIG. 1 will be described with reference to a flowchart shown in FIG. 8. Referring to FIG. 8, the ID issuing apparatus 2 provides a code and a shared secret key to the terminal 4 in step S1. The control unit 15 (FIG. 2) of the ID issuing apparatus 2 reads the code and the shared secret key stored in the storage unit 12. If the risk of interception is sufficiently low, for example, if the code and the shared secret key are directly written to the recording medium 71 of the terminal 4, the code and the shared secret key 71 are provided to the recording medium 71 of the terminal 4 without being encrypted by the encryption unit 13.

On the contrary, if the possibility of interception is not negligible, for example, if the code and the shared secret key are provided via the network 1, the control unit 15 supplies the code and the shared secret key read from the storage unit 12 to the encryption unit 13, where the code and the shared secret key are encrypted, and provides the encrypted code and the encrypted shared secret key from the communication unit 11 to the recording medium 71 of the terminal 4 via the network 1.

The code and the shared secret key may be provided to the recording medium 71 (i.e., to a user) by methods other than being directly written or written via the network 1 to the recording medium 71. For example, the code and the shared secret key may be provided to a user by writing the code and the shared secret key to the recording medium 71 in advance and selling the recording medium 71 to the user.

When the code and the shared secret key are received from the ID issuing apparatus 2, the recording medium 71 of the terminal 4 writes the code and the shared secret key in step S11. If neither of the code and the shared secret key is encrypted, the writing unit 82 (FIG. 6) writes directly the code and the shared secret key received via the interface 81 to the table stored in the table storage unit 83.

If the code and/or the shared secret key received are encrypted, the writing unit 82 decrypts the code and/or the secret key and writes the results to the table stored in the table storage unit 83. If the recording medium 71 itself is not capable of exchanging data via the network 1, the code and the shared secret key are received by the communication unit 95 of the main unit 72 under the control of the control unit 96 while the recording medium 71 is in connection with the main unit 72. The code and the shared secret key are then supplied to the writing unit 82 via the interface 91 and via the interface 81 of the recording medium 71, and written to the table stored in the table storage unit 83.

The code and the shared secret key may both be encrypted, or only one of these items may be encrypted.

In step S12, the recording medium 71 is connected to the main unit 72. Step S12 is omitted if the recording medium 71 is already in connection with the main unit 72. In step S13, the control unit 15 of the recording medium 71 reads a code from the table stored in the storage unit 12. The code is then supplied to the main unit 72.

In step S21, the main unit 72 generates an address. The control unit 96 of the main unit 72 supplies the code received via the interface 91 to the address generating unit 92. The address generating unit 92 generates a source address by combining the code with the network ID assigned to the terminal 4. Furthermore, the control unit 96 of the main unit 72 issues an instruction for generating a session key to the session-key generating unit 93.

The session-key generating unit 93 generates a session key, for example, by generating a pseudo-random number. The session key generated is supplied to the recording medium 71. In step S14, the recording medium 71 supplies the session key received via the interface 81 to the writing unit 82, and the writing unit 82 writes the session key in the table stored in the table storage unit 83.

In step S15, the reading unit 84 reads the session key written in step S14 and the shared secret key that has already been written, and supplies the session key and the shared secret key to the encryption unit 85. In step S16, the encryption unit 85 encrypts the session key using the shared secret key. The encrypted session key is supplied to the main unit 72. In step S23, the main unit 72 sends the encrypted session key to the service providing apparatus 3.

Furthermore, in step S24, the main unit 72 generates authentication data and also sends the authentication data to the service providing apparatus 3. The authentication data includes the source address generated by the address generating unit 92, and data obtained by applying a hash function on the source address with the session key read from the table storage unit 83.

A hash function is one of the methods that are used to generate authentication data, and it calculates and outputs data (authentication data in this case) of a predetermined length for a given character string (a source address in this case). Data obtained by a hash function does not allow restoration of the original data.

The authentication data generated by calculating a hash function is included in a transmission packet, which is transmitted to the service providing apparatus 3. Although other data is also included in the transmission packet, for convenience of description, only data that is particularly relevant is mentioned herein.

In this manner, the service providing apparatus 3 receives the session key encrypted using the shared secret key and the transmission packet including the authentication data from the terminal 4.

The code included in the source address in the authentication data received by the service providing apparatus 3 is supplied to the ID issuer determination unit 62 (FIG. 4). In step S31, the ID issuer determination unit 62 searches the table stored in the table storage unit 63 to determine the ID issuing apparatus 2 associated with the code supplied. That is, the ID issuer determination unit 62 determines the ID issuing apparatus 2 that has provided the code to the terminal 4.

In step S32, the service providing apparatus 3 transfers the code and the session key encrypted using the shared secret key to the ID issuing apparatus 2 determined by the ID issuer determination unit 62. In step S2, the decryption unit 14 (FIG. 2) of the ID issuing apparatus 2 decrypts the session key encrypted with the shared secret key, using the shared secret key it stores, associated with the code. In step S3, the decrypted session key is transmitted to the service providing apparatus 3.

In step S34, the service providing apparatus 3 executes an authentication process. The authentication unit 64 of the service providing apparatus 3 applies the hash function to the source address stored, using the session key received. This process is similar to the process for generating authentication data, executed by the authentication-data generating unit 94 in step S24. Thus, the data calculated by the authentication unit 64 using the hash function usually coincides with the authentication data generated by the authentication-data generating unit 94 of the terminal 4 (authentication data transmitted in the transmission packet and stored at the service providing apparatus 3).

In case of an unauthorized act, however, the authentication data generated by the authentication unit 64 does not coincide with the authentication data received and stored. The authentication unit 64 proceeds to step S35 only if the authentication data it generated coincides with the authentication data received and stored, requesting the control unit 61 to start providing a service. If the authentication data do not coincide with each other, the control unit 61 is instructed not to start providing a service.

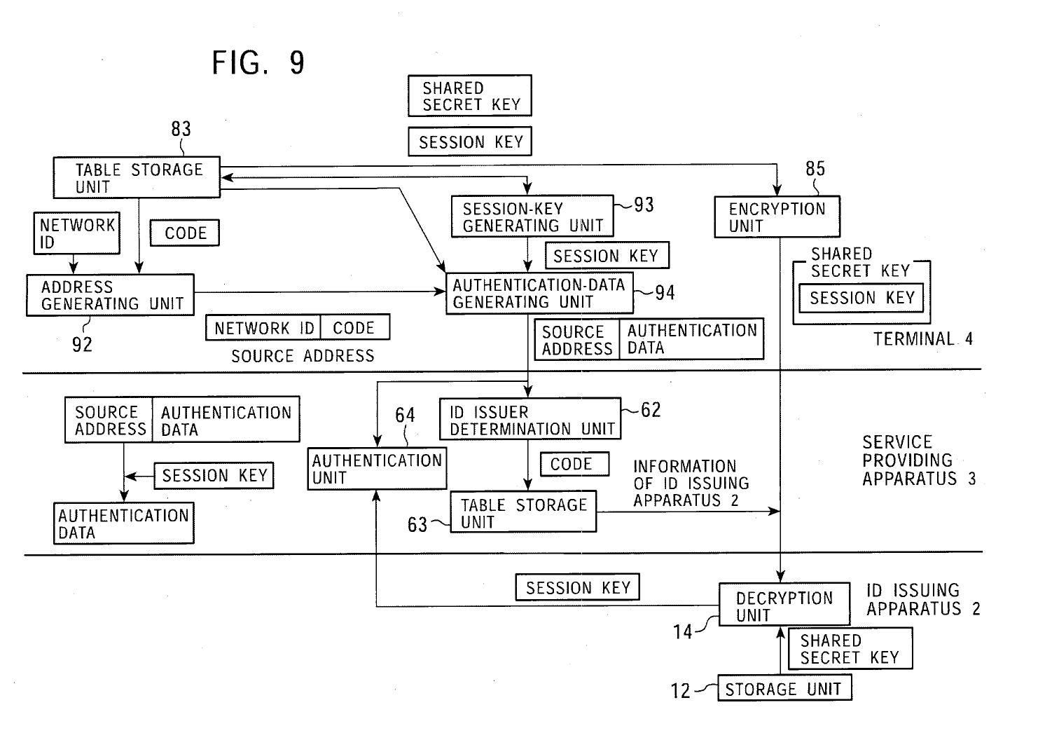

The authentication process will be described further with reference to FIG. 9. In FIG. 9, only parts relevant to the following description are shown. Referring to FIG. 9, a code is read from the table stored in the table storage unit 83 of the recording medium 71 (step S1). The code is supplied to the address generating unit 92, and also a network ID is supplied to the address generating unit 92 from an apparatus in charge of managing the network to which the terminal 4 is connected.

In step S21, the address generating unit 92 generates a source address by combining the code and the network ID supplied thereto. As described earlier, if the source address is generated based on IPv6, the code and the network ID each consist of 64 bits and the source address thus consists of 128 bits.

The source address generated is supplied to the authentication-data generating unit 94. Also, a session key read from the table storage unit 83 is supplied to the authentication-data generating unit 94. Although it has been described that the session key generated by the session-key generating unit 93 and written to the table stored in the table storage unit 83 is read, alternatively, the session key generated by the session-key generating unit 93 may be directly supplied to the authentication-data generating unit 94.

The session key may be updated at a regular interval, for example, every ten seconds, every minute, or every hour, or the session key once generated and stored may be used without updating. Whether the session key is updated or not updated, when the recording medium 71 is connected to the main unit 72 of the terminal 4, it is checked whether a session key is stored in the table storage unit 83. If the control unit 86 of the recording medium 71 determines that a session key is not stored, the control unit 96 requests the session-key generating unit 93 to generate a session key.

The session key generated by the session-key generating unit 93 is stored in the table storage unit 83. In a case where the session key is updated, a new session key is written to the table storage unit 83 on every update. In a case where the session key is not updated, the session key stored in the table storage unit 83 is read as needed without updating.

In the case where the session key is updated, a new session key is stored in the table storage unit 83 on every update. A new session key (referred to as session key B herein) is generated based on a session key stored (referred to as session key A herein). More specifically, when at a timing for updating session key, the control unit 96 requests the control unit 86 of the recording medium 71 to read a session key A stored in the table storage unit 83.

In response to the request, the control unit 86 requests the reading unit 84 to read the session key A, whereby the control unit 86 obtains the session key A. The control unit 86 supplies the session key A to the control unit 96 of the main unit 72. The control unit 96 supplies the session key A to the session-key generating unit 93. The session-key generating unit 93 generates a new session key B using the session key A. The session key B generated is stored in the table storage unit 83 to replace the session key A.

Returning to description of the authentication process with reference to FIG. 9, the authentication-data generating unit 94 generates authentication data including the source address generated by the address generating unit 92 and data obtained by applying a hash function on the source address with the session key generated by the session-key generating unit 93 or the session key read from the table storage unit 83. The authentication data is included in a transmission packet, which is sent to the service providing apparatus 3 (step S24).

The terminal 4, in addition to generating the authentication data, executes encryption by the encryption unit 85. The encryption unit 85 receives a shared secret key and a session key from the table storage unit 83. The encryption unit 85 encrypts the session key using the shared secret key (step S16). Although the arrangement has been described such that the encryption unit 85 is provided in the recording medium 71 and the session key is encrypted in the recording medium 71, the encryption unit 85 may be provided in the main unit 72. In that case, the session key and the shared secret key are supplied to the main unit 72, and encryption is executed in the encryption unit 85 provided in the main unit 72.

If the encryption unit 85 is provided in the main unit 72 and encryption is executed in the main unit 72, however, unencrypted session key and shared secret key are output from the recording medium 71, which incurs a possibility of interception and abuse, raising a security problem. Thus, if the encryption unit 85 is provided in the main unit 72, a measure should be taken to prevent interception.

The session key encrypted by the encryption unit 85 is transmitted to the ID issuing apparatus 2 via the service providing apparatus 3. This is because a destination of sending the session key is determined by the service providing apparatus 3. The service providing apparatus 3 receives from the terminal 4 a source address, and authentication data contained in a transmission packet including the source address.

The ID issuer determination unit 62 of the service providing apparatus 3 extracts a code included in the source address received. As described earlier, the source address includes a network ID and the code, and is not encrypted, so that the code can be simply extracted. The ID issuer determination unit 62 determines the ID issuing apparatus 2 associated with the code, to which the encrypted session key received will be transferred, by searching the table stored in the table storage unit 63.

The encrypted session key and the code are transmitted to the ID issuing apparatus 2 determined. The decryption unit 14 of the ID issuing apparatus 2 decrypts the encrypted session key received, using the shared secret key associated with the code, stored in the storage unit 12. The session key that has been decrypted is supplied to the authentication unit 64 of the service providing apparatus 3. The authentication unit 64 also receives a source address and authentication data included in a transmission packet.

The authentication unit 64 applies the hash function on the source address received, using the session key supplied from the decryption unit 14 of the ID issuing apparatus 2. If the data obtained by applying the hash function on the source address coincides with the authentication data supplied, a service starts to be provided. In case of a mismatch, it is presumed that an unauthorized act has been made, so that a service is not provided.

By the executing the authentication process in the manner described above, a user is not required to enter information needed for authentication each time when receiving a service. Thus, the user is saved work and is prevented from being bothered.

The terminal 4 is not limited to a specific type of apparatus, and may be, for example, a portable personal computer or a television receiver. If a user receiving a service by a portable personal computer, subsequent to the authentication process described above, wishes to continuously receive the service by a television receiver, the user is allowed to continuously receive the service by switching connection of the recording medium 71 from the portable personal computer to the television receiver.

This indicates that only by switching connection of the recording medium 71 among a plurality of terminals, similar authentication processes can be executed, authentication status can be transferred among the terminals, and a user is not required to renew setting even if a network connection is altered. Thus, even if a single user uses a plurality of terminals, the user is not required to perform operations associated with authentication individually for each of the terminals.

The codes described hereinabove may be assigned individually for services provided by the service providing apparatus 3. That is, the codes are used as identifiers of services. Furthermore, for example, if a service is to be provided during a particular period, a code is changed when the particular period expires. Thus, the service is provided only during the particular period.

Although the ID issuing apparatus 2 and the service providing apparatus 3 in the embodiment described above has been described as separate apparatuses (separately managed), alternatively, the functions of the ID issuing apparatus 2 and the service providing apparatus 3 may be integrated into a single ID and service providing apparatus 101 shown in FIG. 10. For example, the ID and service providing apparatus 101 is configured as shown in FIG. 11.

Referring to FIG. 11, a communication unit 102 exchanges data with the terminal 4 via the network 1. A table storage unit 103 stores a table shown in FIG. 12, in which codes, shared secret keys, and service lists are associated with each other. If the functions of the ID issuing apparatus 2 and the service providing apparatus 3 are integrated into the single ID and service providing apparatus 101, the codes need not serve the purpose of identifying the ID issuing apparatus 2, and need only a number of bits sufficient for identifying services.

A decryption unit 104 is equivalent in function to the decryption unit (FIG. 2) of the ID issuing apparatus 2. In this example, the decryption unit 104 decrypts an encrypted session key received via the communication unit 102 from the terminal 4, using a shared secret key stored in the table storage unit 103. The session key that has been decrypted is supplied to an authentication unit 105. The authentication unit 105 is equivalent in function to the authentication unit 64 (FIG. 4) of the service providing apparatus 3, and it determines whether a request from the terminal 4 for a service is valid.

An encryption unit 106 is equivalent in function to the encryption unit 13 (FIG. 2) of the ID issuing apparatus 2. The encryption unit 106 encrypts a code and a shared secret key as required, supplying the results to the recording medium 71 of the terminal 4. A control unit 107 controls each of the units of the ID and service providing apparatus 101.

An operation of the ID and service providing apparatus shown in FIG. 11 and the terminal 4 will be described with reference to a flowchart shown in FIG. 13. Steps S51 to S56 and steps S61 to S64 in the flowchart shown in FIG. 13, executed at the terminal 4, are the same as steps S11 to S16 and steps S21 to S24 in the flowchart shown in FIG. 8, respectively, and thus descriptions thereof will be omitted. It is to be noted, however, that a code and a shared secret key that are written to the recording medium 71 of the terminal 4 in step S51 in the flowchart shown in FIG. 13 are supplied from the ID and service providing apparatus 101.

The ID and service providing apparatus 101 executes decryption in step S72. In order to execute decryption, first, the table in the table storage unit 103 is searched on the basis of a code included in an address received via the communication unit 102 from the terminal 4, whereby a shared secret key associated with the code is read. Then, an encrypted session key received from the terminal 4 is decrypted using the shared secret key.

In step S73, authentication data transmitted from the terminal 4 is stored. In step S74, the authentication unit 105 executes an authentication process using the session key that has been decrypted. The authentication process is basically the same as the authentication process in step S34 in the flowchart shown in FIG. 8. Only when authentication succeeds, the procedure proceeds to step S75 and a service starts to be provided.

As described above, the present invention may be embodied by the single ID and service providing apparatus 101 incorporating the functions of the ID issuing apparatus 2 and the service providing apparatus 3.

The series of processing steps described hereinabove may be executed either by hardware or by software. If the series of processing steps are executed by software, for example, a program of the software is installed on a computer embedded in special hardware, or installed from a recording medium on a general-purpose personal computer that allows execution of various functions with various programs installed thereon.

The recording medium may be a package medium having recorded thereon the program, distributed for providing the program to a user separately from a personal computer, for example, a magnetic disc 51 (including a flexible disc), an optical disc 52 (including a CD-ROM (compact disc read-only memory) and a DVD (digital versatile disc)), a magneto-optical disc 53 (including an MD (mini-disc) (registered trademark)), or a semiconductor memory 54. Alternatively, the recording medium may be, for example, a hard disk including the ROM 32 and the storage unit 38, which is embedded in a computer and provided to a user together with the computer.

The steps of the program provided via the medium need not necessarily be executed sequentially in the order described herein, and may be executed in parallel or individually.

The term system herein refers to the entirety of a plurality of systems.

What is claimed is:

1. An information processing system comprising:
a first information processing apparatus for providing a service;
a second information processing apparatus for providing information required for receiving the service; and
a third information processing apparatus for receiving the service;
wherein the first information processing apparatus comprises:
storage means for storing an identifier for identifying the second information processing apparatus, and an address of the second information processing apparatus associated with the identifier, the identifier and the address being associated with each other;
transferring means for reading the address of the second information processing apparatus associated with the identifier when data including the identifier and a key that is encrypted are received from the third information processing apparatus, and transferring the key that is encrypted to the second information processing apparatus; and
authentication means for receiving the key that has been decrypted, transmitted from the second information processing apparatus, and executing an authentication process using the key received;
wherein the second information processing apparatus comprises:
decryption means for decrypting the key that is encrypted, transferred by the transferring means; and
returning means for returning the key that has been decrypted by the decryption means to the first information processing apparatus;
and wherein the third information processing apparatus comprises:
generating means for generating the key;
encryption means for encrypting the key generated by the generating means; and
sending means for sending the key encrypted by the encryption means and the data including the identifier to the first information processing apparatus.

2. An information processing apparatus comprising:
storage means for storing an identifier for identifying a first apparatus, and an address of the first apparatus associated with the identifier, the identifier and the address being associated with each other;
receiving means for receiving from a second apparatus data including the identifier as part of an address of the second apparatus, and a key that is encrypted;
transferring means for reading from the storage means the address of the first apparatus associated with the identifier received by the receiving means, and transferring the key that is encrypted to the first apparatus; and
authentication means for receiving the key that has been decrypted by the first apparatus, and executing an authentication process using the key received.

3. An information processing apparatus according to claim 2, wherein the data received by the receiving means includes first data used for authentication, generated by calculation of a hash function using the address of the second apparatus and the key in an unencrypted form, and the authentication means executes the authentication process by determining whether the first data coincides with second data generated by calculation of the hash function using the address received by the receiving means and the key that has been decrypted by the first apparatus.

4. An information processing apparatus according to claim 2, wherein the address of the second apparatus is an address in an address space defined by the Internet Protocol version 6.

5. An information processing method comprising:
a storage-control step of controlling storage of a table in which an identifier for identifying a first apparatus and an address of the first apparatus associated with the identifier are associated with each other;
a reception-control step of controlling reception of data including the identifier as part of an address of a second apparatus, and a key that is encrypted, transmitted from the second apparatus;
a transferring step of reading the address of the first apparatus associated with the identifier received under control in the reception-control step, from the table stored under control in the storage-control step, and transferring the key that is encrypted to the first apparatus; and
an authentication step of receiving the key that has been decrypted by the first apparatus, and of executing an authentication process using the key received.

6. A computer-readable recording medium having recorded thereon a program comprising:
a storage-control step of controlling storage of a table in which an identifier for identifying a first apparatus and an address of the first apparatus associated with the identifier are associated with each other;
a reception-control step of controlling reception of data including the identifier as part of an address of a second apparatus, and a key that is encrypted, transmitted from the second apparatus;
a transferring step of reading the address of the first apparatus associated with the identifier received under control in the reception-control step, from the table stored under control in the storage-control step, and transferring the key that is encrypted to the first apparatus; and
an authentication step of receiving the key that has been decrypted by the first apparatus, and of executing an authentication process using the key received.

7. A program that allows a computer to execute:
a storage-control step of controlling storage of a table in which an identifier for identifying a first apparatus and an address of the first apparatus associated with the identifier are associated with each other;
a reception-control step of controlling reception of data including the identifier as part of an address of a second apparatus, and a key that is encrypted, transmitted from the second apparatus;
a transferring step of reading the address of the first apparatus associated with the identifier received under control in the reception-control step, from the table stored under control in the storage-control step, and transferring the key that is encrypted to the first apparatus; and
an authentication step of receiving the key that has been decrypted by the first apparatus, and of executing an authentication process using the key received.

8. An information processing apparatus comprising:
storage means for storing an identifier assigned to the information processing apparatus, and a predetermined key, the identifier and the predetermined key being associated with each other;
providing means for providing the identifier and the predetermined key stored in the storage means to a first apparatus;
decryption means for decrypting data that is encrypted, using the predetermined key stored in the storage means, when the data is received from a second apparatus; and
sending means for sending the data that has been decrypted by the decryption means to the second apparatus.

9. An information processing apparatus according to claim 8, further comprising:
encryption means for encrypting at least one of the identifier and the predetermined key provided by the providing means.

10. An information processing method comprising:
a storage-control step of controlling storage of an identifier assigned to an information processing apparatus that executes the information processing method, and of a predetermined key, the identifier and the key being associated with each other;
a providing step of providing the identifier and the predetermined key stored under control in the storage-control step to a first apparatus;
a decryption step of decrypting data that is encrypted, using the predetermined key stored under control in the storage-control step, when the data is received from a second apparatus; and
a sending-control step of controlling sending of the data that has been decrypted in the decryption step to the second apparatus.

11. A computer-readable recording medium having recorded thereon a program comprising:
a storage-control step of controlling storage of an identifier assigned to an information processing apparatus that executes the program, and of a predetermined key, the identifier and the key being associated with each other;
a providing step of providing the identifier and the predetermined key stored under control in the storage-control step to a first apparatus;
a decryption step of decrypting data that is encrypted, using the predetermined key stored under control in the storage-control step, when the data is received from a second apparatus; and
a sending-control step of controlling sending of the data that has been decrypted in the decryption step to the second apparatus.

12. A program that allows a computer to execute:
a storage-control step of controlling storage of an identifier assigned to the computer, and of a predetermined key, the identifier and the key being associated with each other;
a providing step of providing the identifier and the predetermined key stored under control in the storage-control step to a first apparatus;
a decryption step of decrypting data that is encrypted, using the predetermined key stored under control in the storage-control step, when the data is received from a second apparatus; and
a sending-control step of controlling sending of the data that has been decrypted in the decryption step to the second apparatus.

13. An information processing apparatus comprising:
first generating means for generating a key;
second generating means for generating an address of the information processing apparatus, the address including an identifier for identifying a first apparatus, supplied from the first apparatus;
third generating means for generating authentication data using the key generated by the first generating means and the address generated by the second generating means; and
sending means for sending the key generated by the first generating means and encrypted by a second apparatus, and the address generated by the second generating means, together with the authentication data generated by the third generating means, to a third apparatus.

14. An information processing apparatus according to claim 13, wherein the identifier is supplied from the first apparatus to the second apparatus and stored in the second apparatus, and the second generating means generates an address including the identifier stored in the second apparatus.

15. An information processing apparatus according to claim 13, wherein the first generating means updates the key at a predetermined interval.

16. An information processing apparatus according to claim 13, wherein the third generating means generates authentication data by calculation of a hash function using the address generated by the second generating means and the key generated by the first generating means.

17. An information processing method comprising:
a first generating step of generating a key;
a second generating step of generating an address of an information processing apparatus that executes the information processing method, the address including an identifier for identifying a first apparatus, supplied from the first apparatus;
a third generating step of generating authentication data using the key generated in the first generating step and the address generated in the second generating step; and
a sending-control step of controlling sending of the key generated in the first generating step and encrypted by a second apparatus, and of the address generated in the second generating step, together with the authentication data generated in the third generating step, to a third apparatus.

18. A computer-readable recording medium having recorded thereon a program comprising:
a first generating step of generating a key;
a second generating step of generating an address of an information processing apparatus that executes the program, the address including an identifier for identifying a first apparatus, supplied from the first apparatus;
a third generating step of generating authentication data using the key generated in the first generating step and the address generated in the second generating step; and
a sending-control step of controlling sending of the key generated in the first generating step and encrypted by a second apparatus, and of the address generated in the second generating step, together with the authentication data generated in the third generating step, to a third apparatus.

19. A program that allows a computer to execute:
a first generating step of generating a key;
a second generating step of generating an address of the computer, the address including an identifier for identifying a first apparatus, supplied from the first apparatus;
a third generating step of generating authentication data using the key generated in the first generating step and the address generated in the second generating step; and
a sending-control step of controlling sending of the key generated in the first generating step and encrypted by a second apparatus, and of the address generated in the second generating step, together with the authentication data generated in the third generating step, to a third apparatus.

20. An information processing apparatus comprising:
storage means for storing an identifier supplied from a first apparatus, and a first key associated with the identifier;
reading means for reading the identifier and the first key stored in the storage means when a second key is supplied from a second apparatus;
encryption means for encrypting the second key using the first key read by the reading means; and
supplying means for supplying the identifier read by the reading means and the second key encrypted by the encryption means to the second apparatus.

21. An information processing apparatus according to claim 20, further comprising decryption means for decrypting the first key when the first key is encrypted.

22. An information processing method comprising:
a storage-control step of controlling storage of an identifier supplied from a first apparatus and of a first key associated with the identifier;
a reading-control step of controlling reading of the identifier and the first key stored under control in the storage-control step when a second key is supplied from a second apparatus;
an encryption step of encrypting the second key using the first key read under control in the reading-control step; and
a supplying step of supplying the identifier read under control in the reading-control step and the second key encrypted in the encryption step to the second apparatus.

23. A computer-readable recording medium having recorded thereon a program comprising:
a storage-control step of controlling storage of an identifier supplied from a first apparatus and of a first key associated with the identifier;
a reading-control step of controlling reading of the identifier and the first key stored under control in the storage-control step when a second key is supplied from a second apparatus;
an encryption step of encrypting the second key using the first key read under control in the reading-control step; and
a supplying step of supplying the identifier read under control in the reading-control step and the second key encrypted in the encryption step to the second apparatus.

24. A program that allows a computer to execute:
a storage-control step of controlling storage of an identifier supplied from a first apparatus and of a first key associated with the identifier;
a reading-control step of controlling reading of the identifier and the first key stored under control in the storage-control step when a second key is supplied from a second apparatus;
an encryption step of encrypting the second key using the first key read under control in the reading-control step; and
a supplying step of supplying the identifier read under control in the reading-control step and the second key encrypted in the encryption step to the second apparatus.

25. An information processing system comprising:
a first information processing apparatus for providing a service; and
a second information processing apparatus for receiving the service;
wherein the first information processing apparatus comprises:
storage means for storing an identifier for identifying a service, and identity of the service associated with the identifier, the identifier and the identity of the service being associated with each other;
decryption means for decrypting a key that is encrypted, when the key is received from the second information processing apparatus; and
authentication means for executing an authentication process using the key that has been decrypted by the decryption means;
and wherein the second information processing apparatus comprises:
generating means for generating the key;
encryption means for encrypting the key generated by the generating means; and
sending means for sending the key encrypted by the encryption means and data including the identifier to the first information processing apparatus.

26. An information processing apparatus comprising:
storage means for storing an identifier for identifying a service, and identity of the service associated with the identifier, the identifier and the identity of the service being associated with each other;
receiving means for receiving at least an address of a predetermined apparatus, authentication data, and a key that is encrypted, transmitted from the predetermined apparatus;
decryption means for decrypting the key that is encrypted, received by the receiving means; and
authentication means for executing an authentication process by determining whether data generated by calculation of a hash function using the address received by the receiving means and the key that has been decrypted by the decryption means coincides with the authentication data received by the receiving means.

27. An information processing method comprising:
a storage-control step of controlling storage of an identifier for identifying a service and of identity of the service associated with the identifier, the identifier and the identity of the service being associated with each other;
a reception-control step of controlling reception of at least an address of a predetermined apparatus, authentication data, and a key that is encrypted, transmitted from the predetermined apparatus;
a decryption step of decrypting the key that is encrypted, received under control in the reception-control step; and
an authentication step of executing an authentication process by determining whether data generated by calculation of a hash function using the address received under control in the reception-control step and the key that has been decrypted in the decryption step coincides with the authentication data received under control in the reception-control step.

28. A computer-readable recording medium having recorded thereon a program comprising:
a storage-control step of controlling storage of an identifier for identifying a service and of identity of the service associated with the identifier, the identifier and the identity of the service being associated with each other;
a reception-control step of controlling reception of at least an address of a predetermined apparatus, authentication data, and a key that is encrypted, transmitted from the predetermined apparatus;
a decryption step of decrypting the key that is encrypted, received under control in the reception-control step; and
an authentication step of executing an authentication process by determining whether data generated by calculation of a hash function using the address received under control in the reception-control step and the key that has been decrypted in the decryption step coincides with the authentication data received under control in the reception-control step.

29. A program that allows a computer to execute:
a storage-control step of controlling storage of an identifier for identifying a service and of identity of the service associated with the identifier, the identifier and the identity of the service being associated with each other;
a reception-control step of controlling reception of at least an address of a predetermined apparatus, authentication data, and a key that is encrypted, transmitted from the predetermined apparatus;
a decryption step of decrypting the key that is encrypted, received under control in the reception-control step; and
an authentication step of executing an authentication process by determining whether data generated by calculation of a hash function using the address received under control in the reception-control step and the key that has been decrypted in the decryption step coincides with the authentication data received under control in the reception-control step.
